(19) United States
(12) Patent Application Publication
(10) Pub. No.: US 2020/0353366 A1
(43) Pub. Date: Nov. 12, 2020

(54) SYSTEM AND METHOD FOR AUGMENTED REALITY GAME SYSTEM

(71) Applicant: GOLDEN POPPY, INC., Los Altos, CA (US)

(72) Inventor: Carrol TITUS, Los Altos Hills, CA (US)

(21) Appl. No.: 15/929,555

(22) Filed: May 8, 2020

Related U.S. Application Data
(60) Provisional application No. 62/846,511, filed on May 10, 2019.

(51) Int. Cl. A63F 13/825; A63F 13/822; A63F 13/69; A63F 13/79; A63F 13/49; G06Q 20/06

(52) U.S. Cl. CPC A63F 13/825; A63F 13/822; A63F 13/69; A63F 13/79; A63F 2300/305; G06Q 20/0655; A63F 2300/8082; A63F 2300/5553; A63F 13/49

(57) ABSTRACT

One or more implementations described herein pertain to an augmented reality game system. In some implementations, the augmented reality gaming system comprises one or more processors configured to execute computer program modules. In some implementations, the computer program modules comprise a quest module configured to facilitate a user quest through a virtual environment and a physical environment. Some implementations utilize a physics engine module configured to input movement data of a virtual player's movement in the virtual environment and output information indicating a virtual world location and movement of a first user avatar. In some implementations, an augmented reality photo module configured to superimpose a graphic overlay onto an image of the player in response to a notification from the quest module that the user has completed the user quest.

### RELATED APPLICATION

This application is a non-provisional of, and claims priority to, U.S. Provisional Patent Application No. 62/846,511 entitled “SYSTEM AND METHOD FOR AUGMENTED REALITY GAME SYSTEM” filed 10 May 2019, which is incorporated by reference, in its entirety, herein.

### FIELD

The present disclosure pertains to a system and method for providing an augmented reality game system.

### BACKGROUND

Augmented reality game systems are known. Augmented reality game systems that utilize both virtual modes and physical modes are also known. Yet current solutions include intensive application resource requirements and lack an immersive self-directed Science Technology Engineering Math (STEM) based play, physical incentives, spontaneous exercise, joyful self-expression, connectivity to nature, group-based problem solving, and collaborative agreement.

### SUMMARY

The implementations described herein address the problem of resource intensive prior art that lack immersive self-directed Science Technology Engineering and Math (STEM) based play, physical incentives, spontaneous exercise, joyful self-expression, connectivity to nature, and group-based problem solving and collaborative agreement. Some implementations may be played by single or multi player and also virtually or via augmented reality using a set of physical clue objects. In some implementation, a player starts in a virtual world after accepting a fantasy challenge or quest and downloading a game application onto their mobile device. In some implementations, players may choose to accelerate learning by watching a pre-game STEM videos.

Some implementations described herein have each player uniquely controlling their own virtual “superhero” moves, navigation and interactions with digital “superhero” characters. Through problem solving and role play, players also uniquely control their acceleration and pathway to hunt for physical prizes in a safe and natural physical setting. Players direct with which other players and for what they trade charms or physical prizes. Thus, each player may control their own uniquely immersive experience from start to finish in a less resource intensive manner. In some implementations, players may decide to extend their learning through the STEM based videos, as described in further detail below

In some implementations, players advance levels within the fantasy challenge by thwarting virtual antagonists, problem solving virtual clues, translating these clues into a natural world setting and collecting physical clue objects. Players may work together to solve clues and find clue objects. Immersive fantasy play may induce some players to sprint to find clue objects in the natural world. These physical clue objects or prizes may be swapped with, or gifted to, other players. Discovered clue objects are also tracked virtually as level prize objects. Players may purchase game assets or hints to solve or help find virtual clues. Games completed are tracked virtually as digital asset. Players may choose to take an augmented reality group or selfie photo to commemorate games or levels completed. In some implementations, players may choose to accelerate learning by watching a post-game STEM video.

Accordingly, one or more aspects of the present disclosure relate to an augmented reality game system. In some implementations, the augmented reality gaming system comprises one or more processors configured to execute computer program modules. In some implementations, the computer program modules comprise a quest module configured to facilitate a user quest through a virtual environment and a physical environment. Some implementations utilize a physics engine module configured to input movement data of a virtual player's movement in the virtual environment and output information indicating a virtual world location and movement of a first user avatar. In some implementations, an augmented reality photo module may be configured to superimpose a graphic overlay onto an image of the player in response to a notification from the quest module that the user has completed the user quest or level challenge.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

In one embodiment, a computer, or processor, implemented method for playing an augmented reality game may include providing a game administrator with game rules for the augmented reality game. The rules may include, among other things, instructions for mapping landmarks in a physical environment with landmarks in a virtual environment of the augmented reality game. The rules may also include instructions for gameplay for one or more players and, in some instances, instructions for how the augmented reality game may be played by a plurality, or group of players, together in a cooperative fashion. The instructions may be provided responsively to the request from the administrator that may be communicated from a computing device operated by the administrator (e.g., a smart phone or computer) to a server that hosts the instructions and/or the augmented reality game that may be downloaded from the server. In some embodiments, the instructions are provided once payment is made via, for example, an e-commerce platform and/or via purchasing of a physical copy of the instructions and/or a kit that includes, for example, the instructions, a code for downloading the augmented reality game, and/or one or more prize packs. The physical environment may be, for example, a park, a museum, an area configured for playing the augmented reality game.

In some embodiments, the augmented reality game may include a narrative character within the virtual environment that interacts with the player. In many instances, the movement in the virtual world and display of the virtual worlds is controlled by a physics module running on the processor.

An indication that the game administrator is ready to start the game may then be received once, for example, the game administrator has placed prizes, that may, in some instances, be provided in the kit in the physical environment according to the instructions. Once the game is ready to start, a player may be provided with a quest to be completed in the virtual environment of the augmented reality game via, for example, downloading of the augmented reality games to a computing device (e.g., smart phone or tablet computer) operated by the player. The quest may include a plurality of challenges for the player to solve either by him or herself and/or cooperatively with one or more collaborators or friends.

The player may then be provided with a first challenge of the plurality of challenges to solve within the virtual environment and navigation instructions for moving the player through the virtual environment may be received. The navigation instructions may move to the player around in the virtual environment so that he or she may solve the first challenge. When the player has successfully completed the first challenge by, for example, moving to a specific spot within the virtual environment, the player may be provided with an instruction to search for a first physical prize the physical environment that may be proximate to a landmark in the physical environment that corresponds to a virtual landmark in the virtual environment associated with completion of the first challenge.

In addition, the player may be provided with a virtual prize within the augmented reality game and a second challenge to for the player to complete responsively to a determination that the first challenge is complete. The processor may than receive navigation instructions to move the player through the virtual environment to solve the second challenge and, responsively to determining that the player has successfully completed the second challenge, the player may be provided with an instruction to search for a second physical prize the physical environment that may be proximate to a landmark in the physical environment that corresponds to a virtual landmark in the virtual environment associated with completion of the second challenge.

The processor may then determine whether the second challenge is a final challenge of the plurality of challenges and, if so, may provide an emotionally intelligent revelation to the player. If the second challenge is not the final challenge of the quest, the player may be provided with a third challenge.

In some instances, the processor may receive an indication (e.g., the player selects a pause button on a graphic user interface) that the player has paused the game to look for the physical prizes in the physical environment prior to providing the second challenge to the player. Additionally, or alternatively, an indication that the player has the obtained the physical prize in the physical environment prior may also be received to providing the second challenge to the player.

The augmented reality game may provide a virtual store (sometimes referred to herein as a “store”) or other interface where the player may, for example, request and/or receive information about the game, a hint for playing the game, embellishments to the game (for example, decorations or creatures to place in the virtual environment or augmented reality photo booth) prizes, and/or virtual currency. The store may be available to the player at any point in the augmented reality game. For example, a player may request, via the store, a hint that may assist the player in solving one of the challenges and the requested hint may be provided to the player. In some embodiments, a player may purchase a token, for a plurality of tokens, from the virtual store. In these embodiments, a request to purchase per tokens may be received from the player and the requested tokens may be provided to the player via the augmented reality game, or virtual store, responsively to a determination that a purchase of the token has been successfully concluded. In some embodiments, purchasing tokens may be made via an e-commerce platform.

In some embodiments, a player may submit a request for a digital asset that may assist the player in solving a challenge or add an embellishment to the augmented reality game via of the virtual store.

In some embodiments, the augmented reality game may provide the player with educational (e.g., language arts and/or STEM-related) information text, audio, and/or video that may be helpful in solving one or more of the challenges provided by the augmented reality game. For example, the processor may provide a video that teaches the player to move in virtual environment of the augmented reality game and operate GUI controls to fly, jump, spin within the virtual environment to solve one or more challenges. Additionally, or alternatively, the processor may provide STEM-related information that teaches the player the laws of motion applied within the virtual environment while playing the game prior to provision of the first challenge. Additionally, or alternatively, the processor may provide STEM-related information that pertains to an avatar's location in the virtual environment associated with all motion based challenges in the game. Additionally, or alternatively, the processor may provide STEM-related information to the player that provides the player with instruction on how to animate and code an augmented reality game of their own. Additionally, or alternatively, the processor may also provide instructions for the player to move around (e.g., jump, run, or spin) in the physical environment. Additionally, or alternatively, the processor may also provide information about the virtual environment and stories relating thereto. For example, the processor may provide video that explains a backstory for how a protagonist is connected to a main character and heads a school of aero-acrobatics, or fairy training school.

In some embodiments, the process may provide an antagonist in the virtual environment, wherein the antagonist acts in the virtual world of the augmented reality game to further challenge the player as they attempt to solve the challenges and/or quest.

In some embodiments, the augmented reality game may encourage collaborative play between two or more players. In these environments, a reward may be provided to the player responsively to a determination that the player solved one of the challenges with a collaborator.

In some embodiments, access to virtual currency tokens (which may be referred to as “tokens” herein) may be provided within the augmented reality game and, in these embodiments, a request to use virtual currency tokens from the player may be received. Then, an accounting and persistence of virtual currency tokens may be provided or otherwise made available to player. The virtual currency tokens may be used to purchase a requested hint, prize or digital asset.

In some embodiments, an indication that the player has paused the game to collaboratively problem solve level challenge in the augmented reality game with other players may be received. The augmented reality game may then be paused. At a later time, a request to resume game play may be received and the game may resume (i.e., un-pause) responsively to the received request.

### BRIEF DESCRIPTION OF THE DRAWINGS

FIG. 1 is a schematic representation of a prior art game system;

FIG. 2 is a schematic representation of an augmented reality gaming system in accordance with one or more implementations of the present invention;

FIG. 3 is a schematic representation of an exemplary augmented reality game system in accordance with one or more implementations of the present invention;

FIG. 4 is a flow chart depicting an exemplary game flow in accordance with one or more implementations of the present invention;

FIG. 5 is a flow chart depicting an exemplary virtual mode flow in accordance with one or more implementations of the present invention;

FIG. 6 depicts an exemplary user interface in accordance with one or more implementations of the present invention;

FIG. 7 depicts a graphical representation of a personalized augmented reality graphical overlay in accordance with one or more implementations of the present invention;

FIGS. 8A and 8B are flow charts depicting an exemplary process for facilitating the play of an augmented reality game in accordance with one or more implementations of the present invention;

FIG. 9 is a block diagram of a kit for playing a portion of an augmented reality game in the physical environment in accordance with one or more implementations of the present invention;

FIG. 10 is a screen shot of an exemplary player interface in accordance with one or more implementations of the present invention; and

FIG. 11 is a graphical representation of a personalized augmented reality overlay in accordance with one or more implementations of the present invention.

### WRITTEN DESCRIPTION

The implementations described herein will now be described in detail with reference to the drawings, which are provided as illustrative examples of the invention so as to enable those skilled in the art to practice the invention. Notably, the figures and examples below are not meant to limit the scope of the implementations described herein to a single embodiment, but other implementations are possible by way of interchange of some or all of the described or illustrated elements.

Moreover, where certain elements of the implementations described herein can be partially or fully implemented using known components, only those portions of such known components that are necessary for an understanding of the implementations described herein will be described, and detailed descriptions of other portions of such known components will be omitted so as not to obscure the invention. As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs).

Implementations described as being implemented in hardware should not be limited thereto, but can include implementations implemented in software, or combinations of software and hardware, and vice-versa, as will be apparent to those skilled in the art, unless otherwise specified herein. In the exemplary implementations described herein, an embodiment showing a singular component should not be considered limiting; rather, the invention is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the implementations described herein encompasses present and future known equivalents to the known components referred to herein by way of illustration.

As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert influence against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

It should be noted that, while one or more operations are described herein as being performed by particular components of system 300, those operations may, in some implementations, be performed by other components of system 300. As an example, while one or more operations are described herein as being performed by components of server 310, those operations may, in other implementations, be performed by components of the mobile device(s) 320, and/or by other components of system 300.

One or more implementations described herein provide a one-of-a-kind modal design, narrative and incentives-based gaming system, which produces surprising results where players are compelled to think, feel and interact in high order social, emotional, collaborative, language arts, STEM and athletic based fantasy play that can be applied to any demographic, not just young girls. The primary value of augmented reality is that it brings components of the digital world into a person's perception of the real world, and does so, not as a simple display of data, but through the integration of immersive sensations that are perceived as natural parts of an environment. Moreover, in some implementations the game may be used as a method and system for STEM based educational purposes.

Some implementations described herein may include user input controls and simulated environment that teaches kids to intuit and act or play out the physical laws of motion. User input controls may be modified to allow changes to the user persona for acceleration or mass or to the user environment for gravitational force for a lesson on kinetic energy based on various modes of a physics engine. In addition, clues could be modified to include analysis of simulated results for that of changes to user persona or environment. Sequentially, tactical prizes and STEM based videos could be modified and added to enhance STEM learning through novel play-based design. The modal game design, narrative and incentives-based gaming system 300 produces surprising results where players are compelled to think, feel and interact in high order social, emotional, collaborative, language arts, STEM and athletic based fantasy play that can be applied to any demographic, not just young girls, as discussed in further detail below.

Accordingly, one or more implementations described herein may provide methods, systems, and modules for enabling users to implement the features and elements of the implementations described herein. One or more implementations may utilize sentimental physical prizes that are interwoven into a narrative to incentivize players to actively seek, collect and share with real-world friends as well as dramatize the presence of the friendly or unfriendly entities in the physical world. As described herein, entities may include characters, spirits, and/or player's avatars. Additionally, one or more implementations use STEM based audio/visual tutorials to enhance and extend STEM based learning from implementing the implementations described herein. A narrative and dialogue employed by the game virtual characters promote high order collaboration, problem solving, language arts, athleticism and emotional intelligence.

Some implementations described herein provide players with a higher order social, emotional, haptic, audio and visual presence in the combined virtual 3D, physical and biological worlds. Players accept quests by downloading the game application to their mobile device which can be hosted on any mobile platform, which is discussed in further detail below. In some implementations, a quest may instruct players to help rescue an imprisoned creature of supernatural, spiritual and sentimental significance, for example. Players receive these quests from a guardian of this supernatural creature and the narratives' supernatural protagonist. For example, in the protagonists' request, players are given instructions to find a friendly spirit in a virtual world who will give them their first level clue. Players receive instructions and are told to thwart an antagonist along the way to successfully fulfill the quest, as described in further detail below.

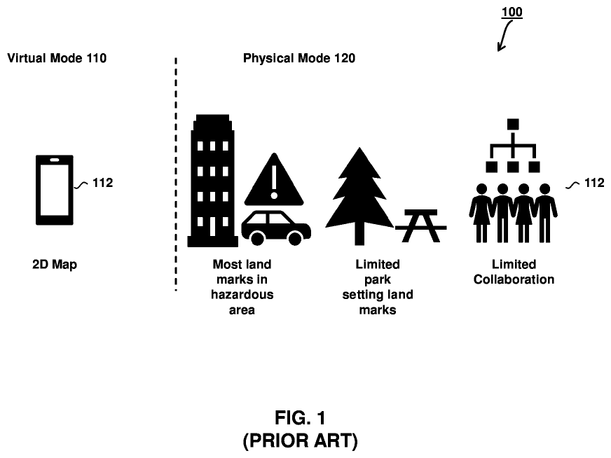

Referring now to FIG. 1, FIG. 1 depicts an exemplary prior art augmented reality system 100 using smart phone 112 having 2D location-based API to integrate virtual mode 110 and physical mode 120. The 2D location-based services of prior art system such as system 100 pull significant CPU and memory resources that require significant download time and storage space. This problem limits the amount of resources to support a 3D physics engine and an optimal immersive user experience. Players 112 will not feel or act as a superhero as they would when experiencing the effects of movement in 3D virtual space. Players 112 will not intuit physics nor the joyful self-expression of it. Furthermore, although prior art systems such as system 100 are “multi-player” the multi-player interaction is limited in real-time social connectivity with friends. All prizes collected and gifted are virtual.

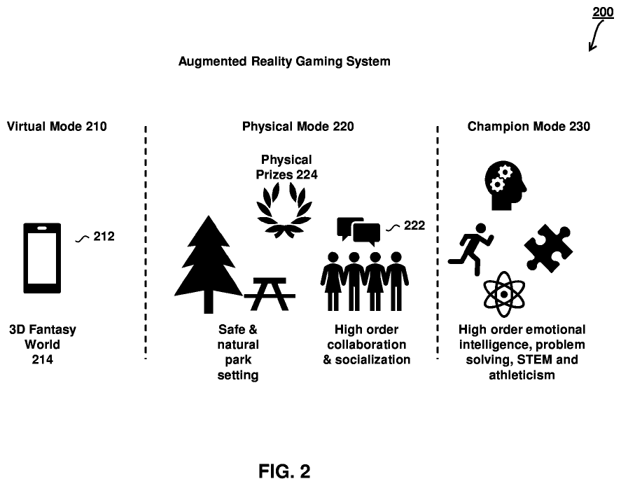

Referring now to FIG. 2, FIG. 2 depicts an augmented reality system 200, in accordance with one or more implementations. As shown in FIG. 2, system 200 features the integration of 3D virtual world 210, physical mode 220 and biological “Champion” mode 230, which offers a technical solution for a more immersive and superior experience for users. In some implementations, utilizing mobile device 212 in communication with a physics engine (not shown in FIG. 2), each player 222 uniquely controls their own virtual “superhero” moves in a 3D Fantasy world 214, navigation and interactions with digital “superhero” characters (not shown in FIG. 2), discussed in further detail below.

In some implementations, players 222 decide whether to extend their learning through the STEM based videos available for viewing by way of mobile device 212. Through problem solving and role play, players may uniquely control their acceleration and pathway to hunt for physical prizes 224. Players 222 direct with which other players 222, and for what, they trade physical prizes 224. Thus, each player 222 controls their own uniquely immersive experience from start to finish. Players are presented and may accept a narrative quest whereby digital characters leave physical prizes 224 for them in the physical world. The immersive fantasy and 3D play induce players to sprint, intuit and extend STEM learning as well as collaborate, trade and come to agreement with other peers in the quest.

In some implementations, upon accepting the challenge of the quest and optional STEM based champion training the player becomes their own “superhero” within the game. Superheroes within the game may interact with the other “superhero” digital characters. By playing the game players intuit physics by learning how to jump, fly and 360-degree spin in the air in 3D by using the graphical user interface input controls, which is discussed in further detail below.

In some implementations, players 222 may experience a more immersive state due to an underlying physics engine (not shown in FIG. 2) that allows them to move beyond their physical world limitations. This immersive state coupled with their desire to move beyond antagonistic dialogue compels players 222 to spontaneously sprint to physical prizes 224 in the physical world akin to their virtual persona. In addition, by playing the game, players 222 learn high-order collaborative problem solving with peers and are rewarded with a set of physical prizes 224 and a new challenge at each shared success. Players 222 may choose to trade physical prizes 224 with peers based on mutual agreement.

For example, in some implementations, promoting collaboration may include having physical prizes 224 include clues at any stage of the game. Each physical prize of Physical prizes 224 may, in some implementations, individually contain partial clue information. In aggregate, physical prizes 224 may reveal the clue or contain all information required to solve a puzzle, thereby compelling players 222 to work cooperatively together (i.e., promote collaboration). Trading physical prizes with mutual agreement in this manner not only increases the required level of collaboration, but also imparts social and emotional intelligence skills. Furthermore, playing the game also peaks player's interest in STEM based inquiry. For example, in some implementations, players 222 may choose to enhance their learning with an optional STEM-based software design tutorial.

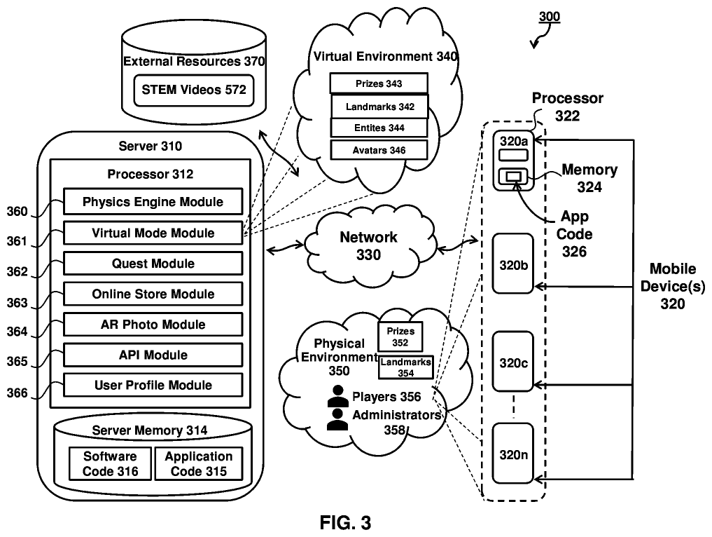

Referring now to FIG. 3, FIG. 3 depicts an exemplary augmented reality game system 300, in accordance with one or more implementations. As shown in FIG. 3, game system 300 includes server 310, mobile device 320a, 320b, 320c . . . 320n (hereinafter “mobile device(s) 320”), network 330, virtual environment 340, physical environment 350, and external resources 370. In some implementations, server 310 may include processor 312 and server memory 314 having storing software code 316 stored thereon. Processor 312 may be in communication with memory 314 and configured to execute software code 315 in order to implement the exemplary implementations described herein. Software code 315 may include non-transitory computer readable instructions that when executed by processor 312 implement one or more implementations described herein.

In some implementations, game system 300 includes a virtual environment 340 and physical environment 350. Physical environment 350 may include one or more predetermined geographic locations that are suitable for implementing the exemplary implementations described herein. For example, physical environment 350 may include child friendly public parks which are free of traffic congestion and dangerous hazards wherein a parent may supervise the players of the game to ensure adequate safety during gameplay. In some implementations, physical environments 350 include physical prizes 352 and landmarks 354. Landmarks 354 may include physical landmarks such as trees, grass, boulders, hills and mountains, and/or other physical landmark (e.g. buildings, structures, rivers, and the like).

In some implementations, virtual mode module 361 may facilitate one or more virtual environment 340. In some implementations, virtual environment 340 may include virtual landmarks 342, entities 344, and player avatars 346. As discussed in further detail below, entities 344 may include spirits, characters, and the like both as antagonists and/or protagonists. For example, an antagonist may be a bad spirit while a protagonist may be a good spirit. Player avatar 346 may correspond to a virtual persona of a player that is used to navigate through a virtual environment utilizing a graphic user interface and input controls facilitated by mobile device 320, which is described in further detail below. In some implementations, quest module 362 may be configured to facilitate and monitor a user's advancement through a quest. For example, quest module 362 may facilitate the advancement of game flow of a quest (e.g. game flow 400). In some implementations, online store module 363 may facilitate a virtual online store where players may purchase additional prizes and gameplay features by accessing the virtual online store. Described in further detail below, AR photo module 364, API module 365, and user profile module 366 may facilitate providing players an emotionally intelligent revelation which may be facilitated by utilizing a graphic overlay superimposed on an image of the player.

In some implementations, server 310, mobile device(s) 320, and/or external resources 370 may be operatively linked via one or more electronic communication links. For example, such electronic communication links may be established, at least in part, via network 330. For example, network 330 may include the Internet and/or other networks (e.g., broadband data network including 3G, 4G, LTE, 5G, and the like). It will be appreciated that this is not intended to be limiting, and that the scope of this disclosure includes implementations in which server 310, mobile device(s) 320, and/or external resources 370 may be operatively linked via some other communication media.

In some implementations, a given mobile device 320 may include one or more processors configured to execute computer program modules. The computer program modules may be configured to a user associated with the given mobile device 320 to interface with system 300 and/or external resources 370, and/or provide other functionality attributed herein to mobile device(s) 320. By way of non-limiting example, the given mobile device 320 may include one or more of a, a laptop computer, a handheld computer, a Netbook, a Smartphone, a PDA, a gaming console, a desktop, a tablet, and/or other computing platforms. Mobile device 320 may include one or more of: a graphic user interface (GUI) and, a camera, a speaker, a microphone, GPS sensor, and/or motion sensors (e.g., accelerometers, gyroscopes, proximity sensors, and the like).

In some implementations, external resources 370 may include sources of information, hosts and/or providers of virtual environments outside of system 300, external entities participating with system 300, and/or other resources (e.g., social media plugins). In some implementations, some or all of the functionality attributed herein to external resources 370 may be provided by resources included in system 300.

As shown in FIG. 3, system server 310 includes server memory 314, one or more processors 312, and/or other components (e.g., modules 360-366), which are discussed in further detail below. Server 310 may include communication lines, or ports to enable the exchange of information with a network (e.g., network 330) and/or other computing platforms (e.g., mobile device 320). Illustration of system server 310 in FIG. 3 is not intended to be limiting. System server 310 may include a plurality of hardware, software, and/or firmware components operating together to provide the functionality attributed herein to system server 310. For example, system server 310 may be implemented by a cloud of computing environment using physical or virtual devices as a data center.

Server memory 314 may comprise electronic storage media that electronically stores information. The electronic storage media of server memory 314 may include one or both of system storage that is provided integrally (i.e., substantially non-removable) with server 310 and/or removable storage that is removably connectable to server 310 via, for example, a port (e.g., a USB port, a firewire port, etc.) or a drive (e.g., a disk drive, etc.). Server memory 314 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The server memory 314 may include one or more virtual storage resources (e.g., cloud storage, a virtual private network, and/or other virtual storage resources). Server memory 314 may store software algorithms (e.g. software code 316), information determined by processor 312 and/or modules 360-366, information received from server 310, information received from mobile device(s) 320, external resources 370, and/or other information that enables server 310 to perform the exemplary implementations described herein.

Processor(s) 312 is configured to provide information processing capabilities in server 310. As such, processor 312 may include one or more of a digital processor, an analog processor, a digital circuit designed to process information, an analog circuit designed to process information, a state machine, and/or other mechanisms for electronically processing information. Although processor 312 is shown in FIG. 3 as a single entity, this is for illustrative purposes only. In some implementations, processor 312 may include a plurality of processing units. These processing units may be physically located within the same device, or processor 312 may represent processing functionality of a plurality of devices operating in coordination. The processor 312 may be configured to execute modules 360, 361, 362, 363, 364, 365, and/or 366. Processor 312 may be configured to execute modules 360, 361, 362, 363, 364, 365, and/or 366 by software; hardware; firmware; some combination of software, hardware, and/or firmware; and/or other mechanisms for configuring processing capabilities on processor 312.

It should be appreciated that although modules 360, 361, 362, 363, 364, 365, and/or 366 are illustrated in FIG. 3 as being co-located within a single processing unit, in implementations in which processor 312 includes multiple processing units, one or more of modules 360, 361, 362, 363, 364, 365, and/or 366 may be located remotely from the other modules. The description of the functionality provided by the different modules 360, 361, 362, 363, 364, 365, and/or 366 described below is for illustrative purposes, and is not intended to be limiting, as any of modules 360, 361, 362, 363, 364, 365, and/or 366 may provide more or less functionality than is described. For example, one or more of modules 360, 361, 362, 363, 364, 365, and/or 366 may be eliminated, and some or all of its functionality may be provided by other ones of modules 360, 361, 362, 363, 364, 365, and/or 366. As another example, processor 312 may be configured to execute one or more additional modules that may perform some or all of the functionality attributed below to one of modules 360, 361, 362, 363, 364, 365, and/or 366.

As shown in FIG. 3, in some implementations, processor 312 may include physics engine module 360, virtual mode module 361, quest module 362, online store module 363, AR photo module 364, API module 365, and user profile module 366.

In some implementations, physics Engine module 360, may include one or more dedicated processors for implementing a 3D physics engine processor. Utilizing physic engine module 360, players may experience a completely immersive state due to the underlying physics engine that allows them to move beyond their physical world limitations in the virtual environment 340, which, as shown in FIG. 3, may be facilitated by virtual mode module 361. In some implementations, physics engine module 360 implement a physics engine processor that instructs game system 300 how a players' “superhero” characters move about throughout virtual environment 340. For example, physics engine module 362 may perform a variety of calculations in real time to represent realistic and/or exaggerated motions of the players virtual avatars 346 moving about virtual environment 340. In some implementations, virtual environment 340 may include a variety of virtual environment themes each having a corresponding physics engine that may utilize different rules for governing movement within the corresponding virtual environment, corresponding to the particular virtual environment theme, which is discussed in further detail below. In some implementations, a graphical user interface (GUI) can be present to allow a user to control their avatar 346 in the virtual environment 340.

Physics engine module 360 may, in some implementations, support the addition and removal of players (e.g., avatars 346) and virtual objects (e.g., virtual prizes 343) during play in the virtual environment 340. As player's avatars 346 and virtual landmarks 342 are added and removed, physics engine 100 may be updated to reflect the changed physical relationships within virtual environment 340. In some implementations, physics engine module 360 may perform, physics calculations, and communicate feedback information to a player through a tactile medium (e.g. mobile device 320). For example, physics engine module 360 may perform calculations for modeling the motion of a virtual entities 344 and avatars 346 traveling through virtual environment 340. The output of this modelling is then imposed on a graphic user interface (e.g., GUI of mobile device 320, not shown) that corresponds to entity 344 or avatar 346 such that motion in the virtual environment 340 closely matches motion of a real object moving through a real environment (e.g. physical environment 350).

In some implementations, virtual mode module 361 may facilitate virtual environment 340. Virtual environment 340 may include a multitude of virtual environments each having a specific set of rules that govern physics engine module 360 in various ways per the specific virtual environment. Virtual environment 340 may host players journey through a virtual quest. Quest module 362 may facilitate implementing the player narratives, interactive state and quests, which is described in further detail below.

Mobile device(s) 320 include processors 322 and memory 324 storing application software code 326 thereon. Processor(s) 322 may be in communication with memory 324 and configured to execute application software code 326 in order to implement one or more of the exemplary limitations described herein. Application software code 326 may be downloaded onto mobile device 320 from server 310 via network 330. Application software code 326 may be lightweight, loads quickly and uses minimal storage. In some implementations, playing the game does not require wireless or WIFI connectivity. With wireless connectivity, the player may view the optional STEM video 572 utilizing external resources 370, for example. For example, STEM videos 372 on External resources 370 may include access to the Golden Poppy Inc. or other third party video app or system during game play. In some implementations, no WIFI connectivity is required to view the STEM video during game play.

In some implementations, STEM videos 572 may include a multitude of various STEM-based videos. For example, in one implementation, the first STEM video teaches players how to use the user interface controls and the properties of the physics of movement they are inherently learning by playing the game, which is describe in further detail below. STEM-based videos may further include various educational subject matter including but not limited to science, technology engineering and math.

As further shown in FIG. 3, AR game system 300 includes virtual environment 340 having virtual landmarks 342, clue/prizes 343, entities 344 and avatars 346. In some implementations, physical environment 350 may include prizes 352 and landmarks 354. Landmarks 354 may include physical landmarks such as trees, grass patches, boulders and rocks, and the like. Players 356 and administrators 358 utilized physical environment 354 for playing the game with one or more players 356 and at least one administrator 358, which is described in further detail below. Each player 356 may have one or more corresponding avatars 346 in virtual environment. Physical environments 350 include child-friendly outdoor parks, for example, having a child-friendly outdoor setting that allows for adult supervision, freedom of movement away from busy streets and traffic hazards.

In some implementations, administrators 358 receive instructions prior to the beginning of gameplay for choosing a proper physical environment 350. For example, Parents or guardian purchasers of the game kit are given a set of written instructions on how to select or choose child-friendly locations. For example, by instructing to: Pick a kid friendly outdoor setting such as park or backyard where kids can be kids and an adult lead can have a good field of vision. Physical environment 350 may include landmarks 354. Landmarks 354 may include trees, grass, sand, a source of water and clover, for example. Physical environment 350 boundaries may determine the difficulty of the game based on the challenge level and time desired for play. For example, by selecting a larger physical environment 350, physical prizes may be placed farther apart and hidden amongst a larger area, making the game more challenging to play.

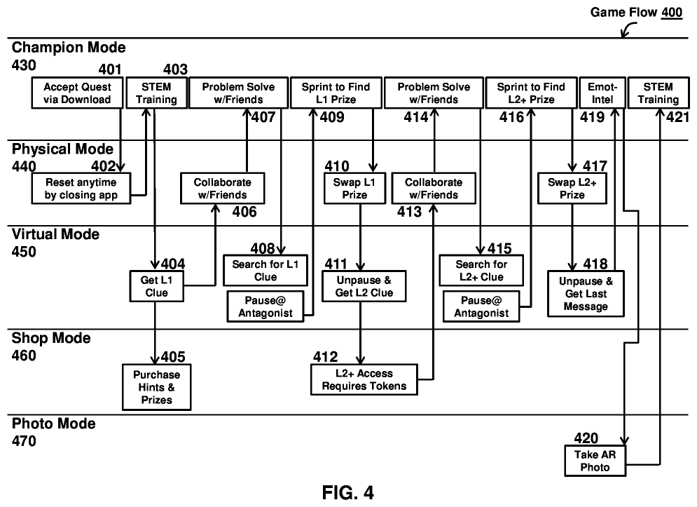

Referring now to FIG. 4, in conjunction with FIG. 3. FIG. 4 illustrates a flow chart depicting an exemplary game flow 400 in accordance with one or more implementations. Game flow 400 illustrates features of game system 300 as delineated by user experience modes including champion mode, physical mode, virtual mode, shop mode, and/or photo mode. Flow 400 may begin at step 401 when a player accepts a quest from quest module 362 which may initiate downloading software code 326 on mobile device 320, via network 330. For example, in some implementations, players may receive the quest within the app/product description when they access the game from the platform service provider (e.g., the app store). User will agree to privacy policy and terms of use license or they will not receive the key to be able to unlock or access the app. In some implementations, terms of use may require account creation with GOLDEN POPPY™ INC., or third party provider to verify parental consent and legal compliance. In some implementations, user profile module 366 may gather user data corresponding to consent and legal compliance.

In some implementations, after accepting quest via download at s401, game flow 400 may continue into physical mode at s402 whereby a player may view a preflight STEM training video at s403. The preflight stem a training video s403 may provide players 356 with instructions on how to move about in the virtual environment 340 and score points by utilizing information learned from preflight STEM training video.

In some implementations, players may receive the first level clue at s404. For example, in some implementations, a first level clue may include a riddle. For example, a riddle may include: Clue 1: Dear Champion, Unicorn Blue has a surprise for you. A charm and a clue hidden in a place where birds rule! Your Friend, Ma-Hoo” Answer is “tree”. So, players must find the virtual prize 343 near a virtual landmark 342 corresponding to the special tree object in the virtual world to get their virtual points and advance to the next level.

Upon receiving their first clue 404 the player may pause the game to problem solve and collaborate with friends at s406. Collaboration with friends at as 406 occurs in physical environment 350, in the real world in order to answer the riddle posed by the friendly spirit. For example, the clue may include a riddle, math problem, or other problem-solving exercise. In some implementations, players may then collaborate with friends at step 406 in order to solve the riddle. Once the riddle is solved the player should un-pause the game to locate the landmark and next clue in the virtual mode. A player will be notified in the virtual mode, via GUI of mobile device 320 that they have found the virtual landmark 342 and next clue when they encounter an antagonist at s408.

In some implementations, when the antagonist virtual event occurs at s408 the player should then pause the virtual mode game and locate physical prizes 352 at s409 in the champion mode and physical environment 350. Physical prizes 352 left for them by the friendly spirits they met in the enchanted forest (e.g. virtual environment 340) are hidden by a similar physical landmark 354 to the virtual landmark 342 but located in the physical environment 350. For example, if a virtual landmark 342 is a tree than the physical landmark 354 in the physical environment 350 should also be a tree. As discussed above, administrators 358 place physical prizes 352 in various places throughout physical environment 350 prior to beginning of the game.

The art of creating a successful narrative and immersive presence requires a pre-mapping of common landmarks between both the virtual and physical modes. as well as identifying sentimental prizes for the particular target demographic in alignment with the character narrative base within the holistic game design. For example, in some implementations were a target demographic may include small children, physical prizes 352 may include bubbles, unicorns, shells, feathers and gem stone rings, and the like. In some implementations with a target demographic that includes bachelorettes, physical prizes 352 may include makeup, soaps, perfume, jewelry, hair ties, hearts, love birds, and the like. Other target demographics may include but are not limited to boys, mentally disabled and/or autistic, partially blind, dyslexic children or adults.

By implementing the exemplary implementations described herein, players 356 may feel so deeply present in the 3D supernatural fantasy play and desire to beat the antagonist and free the imprisoned spirit so much that they will want to run or sprint in the physical environment 350 in order to collect the physical prizes 352 that have sentimental and tactile value and have been presented to them from the friendly spirit who is helping them find the imprisoned super natural creature, for example. As the prizes left by the friendly spirits are found, at step 410, players 356 may want to share, trade or swap with other players 356 physical prizes 352 as well as celebrate collectively the group win.

In some implementations, utilizing a camera device (not shown) on mobile device 320 players 356 may also want to snap a photo of the fairy hiding place to share with friends socially. In one implementation, the camera functionality is separate from the game functionality but can be combined so that a player may take an AR photo with each friendly spirit they encounter at each level. Players keep real-world prizes and can trade or swap at a later time for extended play and social learning. At step 411, after all real-world swaps are complete, players 356 should then un-pause the virtual game to get the second level clue from the next friendly spirit they encounter.

In some implementations, at step 412, after the second level clue is given and if the player has not yet purchased a token pack, they will be redirected to the store portal (e.g., utilizing online store module 363) where they must purchase a token pack in order to access level two and above. In some implementations, a player who purchases the retail game kit will have access to level two and above with no additional purchase required. In some implementations, after purchase of a token pack from the in-app store the player will be redirected to level two in the game menu and will be notified in their GUI interface that they have completed level one and received one virtual prize for completing level one.

In some implementations, a player may receive one virtual prize for each game completed and each level of the game completed. Some implementations combine trading of physical prizes 352 with virtual prizes (not shown) that are traded virtually. For example, players 356 may include 2-6 “physically present” players. The collaborative quest actually fosters friendships among unconnected players (e.g., 2 groups from different schools). In some implementations, player interactions can be digitized with private groups of friends to meet legal compliance. In some implementations, player interactions can be moderated to meet Terms of Use as well as Champion, event and Internet Guidelines set by Golden Poppy Inc. In some implementations, user profile module 366 may be configured to collect and verify administrators 358 (e.g., parent/guardians) emails and/or players 356 emails in order to send more detailed quest description direct to user's e-mail.

In some implementations, application software code 326 may be downloaded on to mobile device(s) 320 and player 356 pushes the start button on a mobile device GUI (not shown) player(s) 356 enter virtual environment 340 displayed on a graphic user interface of mobile device 320. In some implementations, virtual environment 340 may include a virtual enchanted forest where players navigate through the virtual enchanted forest to find the first of a set of friendly spirits (e.g. protagonist entities 344) that will help guide players 356 on their journey to find an imprisoned supernatural creature, for example.

In some implementations, virtual mode module 361 may be in communication with in-app store module 363. For example, entities 344 that a player encounters in the virtual environment 340 has a dwelling that also doubles as a portal for an in-app virtual store hosted by online store module 363. Players may purchase hints to solve and locate virtual clues and other digital game assets and prizes.

In some implementations, physical prizes 352 may include a feather from the tree fairy, gem stone rings from the grass fairy, bubbles from water fairy, sea shells from the sand fairy and a unicorn horn from Princess Keela. For example, children especially love physical prizes 352 because they are a gift from the fairy character from the story line and have sentimental and tactile value. Children are encouraged to trade and swap them with friends as each physical prize 352 has unique colors, shapes, sizes and textures.

In some implementations, a complete retail kit includes pre-kited prize bags, player collection bags, instructions/quest, aerial view of virtual map, certificates of completion and links to tutorials. A player may purchase the standalone app from Golden Poppy Inc. Similarly, a player may purchase a bundled app and prize retail kit from Golden Poppy Inc or other third party retailer. Note that this implementation includes that a bundled app and toy kit has been purchased before download, and the physical prizes have been pre-hidden prior to start of the game, for example, by game administrators 358.

In some implementations, AR game system 300 utilizes administrators 358. Administrators 358 include parents or guardian purchasers of the game kit. Administrators 358, via purchasing a game kit, are given a set of written instructions on how to hide physical prizes 352 while the players are watching the pre-flight STEM video and getting a first quest read to them. Administrators 358 may be instructed where to hide physical prizes 352 (e.g., prizes 352 corresponding to the tree fairy should be hidden next to a corresponding landmark 354 such as a tree). In some implementations, physical prizes 352 corresponding to a fairy's prizes come pre-packaged with a tag that says, “put me by a tree”, for example, for ease of use.

For example, in some implementations, administrator 358 instructions may include, for example: “Have one or more administrators 358 supervise. Have the players gather around a first administrator 358 who will keep players 356 together as the quest leader. The quest leader will read and deliver the quest to the kids while the other adult is hiding the physical prizes 352 in the physical environment 350, as labeled e.g., hide the tree charms by a large tree and grass charms by a flat patch of grass). In some implementations, to make the game longer and more challenging, physical prizes 352 may be placed on opposite sides of physical environment 350.

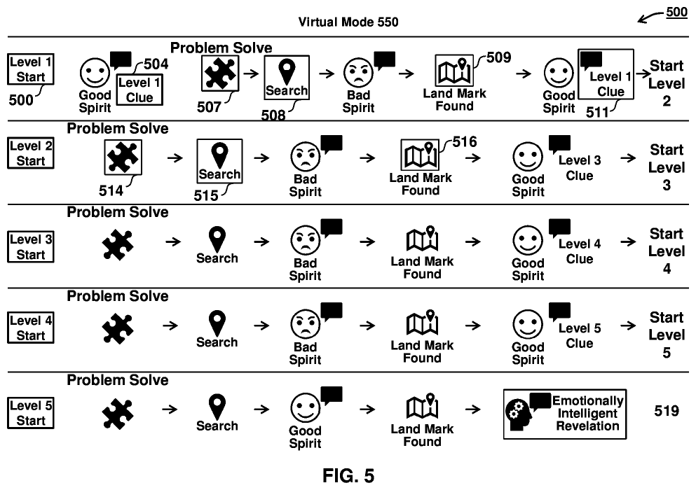

Referring now to FIG. 5, in conjunction with FIG. 3 and FIG. 4, FIG. 5 depicts an exemplary flow chart, illustrating an exemplary game flow 500 as experienced by a player in the virtual mode (e.g. virtual mode 450 of game flow 400) of game system 300, in accordance with some implementations. As shown in FIG. 5, virtual mode 550 loops through five levels when the quest is complete. Virtual mode 550 may include similar operations and flow as virtual mode 450 of FIG. 4, wherein similarly labeled blocks correspond to similar operations having similar effect.

As shown in FIG. 5, upon completion of the quest at when the last clue is found the final message the player receives is an emotionally intelligent and powerful revelation 519 that the supernatural creature they have been seeking is actually a force of resilience in their own psyche for the target demographic (e.g. small girls or boys). For example, using AR photo module 364 in conjunction with API module 365, API module 365 may call to a camera of mobile device 320 to facilitate an image of the user that may be utilized for presenting a graphic overlay superimposed on the face of the user. In some implementations, AR photo module 364 may provide access to a variety of graphic overlays. For example, graphic overlays may be stored in server memory 314, or may be fetched from external resources 370. In some implementations, additional graphic overlays may be purchased by players accessing a virtual online store (e.g., the online store module 363).

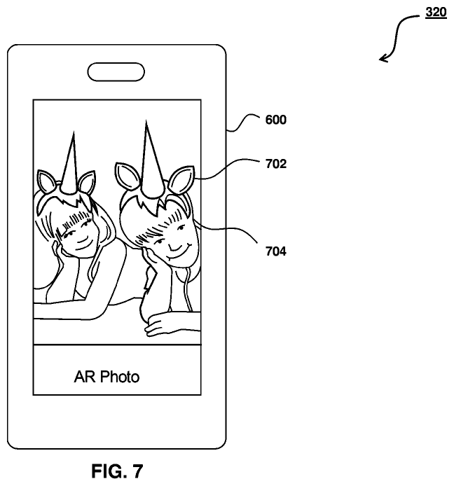

In some implementations, API module 365 may be configured to implement facial recognition software to recognize and determine the boundary of a player's facial image. AR photo module 364 may then superimpose one or more a graphic overlay images onto a player's facial image. In some implementations, graphic overlay images may include one or more of: a partial unicorn, wreath/flowers, ears, eyes, nose, partial animal characters, animated characters, and the like. In some implementations, facial recognition software may be facilitated by API module 365 and/or external resources 370. As shown in FIG. 7, the player may take a personalized AR photo as Unicorn Blue, for example.

In some implementations, API module 365 may be configured to implement object tracking software to recognize and determine the objects in the physical world. AR photo module 364 may then superimpose one or more a graphic overlay images onto a group of objects. In some implementations, graphic overlay images may include one or more of: a sparkles, glitter, animated characters, and the like.

Via this messaging and graphical representation player becomes part of the narrative and is thus challenged to write their own epic story via the accompanying STEM video. For example, STEM videos may show how to design and build a simple game using a software platform (e.g., https://scratch.mit.edu). After completing the game player has the option to view a second STEM video that enhances their learning and enjoyment of the story line by walking them through the software design process and an example game using the game narrative created with a free online development environment for children. The player may view the optional STEM video from the GOLDEN POPPY™ INC., or third-party video app or system during game play. In some implementations, no WIFI connectivity is required to view the STEM video during game play, which may require downloading videos onto device(s) 320 prior to the start of the game, for example.

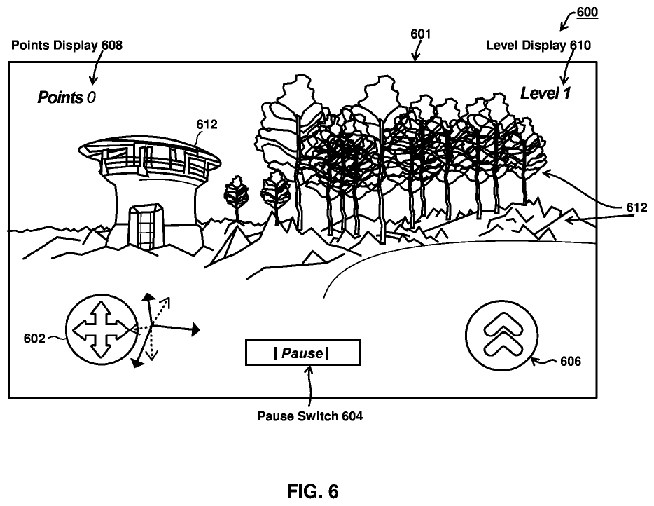

Referring now to FIG. 6 an illustration of a graphic user interface 600 in accordance with one or more implementations. GUI 600 may, in some implementations, display a virtual environment 601. As shown in FIG. 6, virtual environment 601 may be a 3D virtual environment. Virtual environment 601 is depicted as experienced by a player's virtual character or avatar (not shown in FIG. 6). A player's avatar may move throughout virtual environment 601 in order to identify virtual landmarks 612 and find friendly spirits (e.g., virtual landmarks 342, antagonist entities 344). As shown in FIG. 6, in some implementations, virtual landmarks 612 may include virtual trees, virtual tall grasses, virtual hills and mountains, virtual flatlands virtual silos and buildings and/or other virtual features.

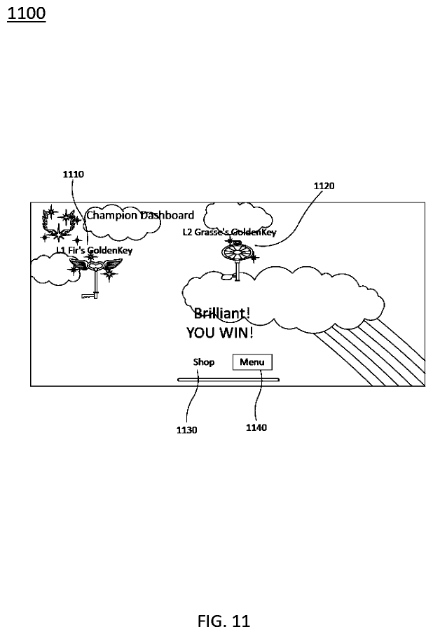

In some implementations, when input commands from controllers 602, 606 are received by the physics engine module 360, physics engine 360 outputs instructions to control the avatar in manner corresponding to the particular physics rules of that particular virtual environment. A player may accumulate virtual prizes which are displayed on player dashboard display as, for example, a number of game points 608 and/or as a previously earned prize list 1110 (e.g., L1 Fir's GoldenKey), on an champion dashboard interface like champion dashboard interface 1100 provided by FIG. 11 and/or as a currently earned prize graphic 1120 (e.g., L2 Grasse's GoldenKey) as they advance throughout different levels. In some implementations, a current level of the player's quest may be displayed on level display 610. Additionally, or alternatively, a current level of the player's quest may be displayed on champion dashboard interface 1100 as indicated by the L1 and L2, which correspond with prizes awarded for levels 1 and 2, respectively. Champion dashboard interface 1100 also provides the player with the opportunity to access a menu via a menu graphic element 1140 and access a shop via a shop graphic element 1130.

In some implementations, a player may accumulate virtual game points that may be displayed on game point display 608. Game points may be accumulated by successfully moving the avatar throughout virtual 601 in unique ways by implementing controllers 602 606 to solve the challenges and complete a quest. For example, a user may input commands the controller 602 606 and cause the avatar to run and jump. In some implementations, physics engine module 360 may, for example, receive run and jump commands via controllers 602, 606 corresponding to an avatar or virtual character. Implementing the particular rules of the environment 601 physics engine which are set for a particular environment 601. For example, in some implementations, virtual environments may include a terrestrial environment, lunar environment, and extraterrestrial environment, and underwater environment, a celestial environment, and/or other environments. Each particular environment may include a unique set of rules implemented by physics engine module 360, for example. That is to say, a player may experience varying levels of movement based on the type of virtual environment presented to the player. For example, in the lunar environment, inputting the jump commands may elevate a player avatar character by factor of 5 compared to implementing the same command on a terrestrial environment, for example. Physics engine module 360 may be configured to implement physics rules that are similar to movement of actual people on earth utilizing known kinematics equations based on Newtonian forces.

Referring now to FIG. 7, FIG. 7 depicts an exemplary mobile device 320 showing is a graphical representation of a personalized augmented reality graphical overlay 702 which has been superimposed over an image 704, in this instance an image of two players. As discussed above, in some implementations, upon completing the quest players may be rewarded with higher order emotional intelligence revelation. The revelation may include utilizing AR photo module 364 and/or API module 365 to input an image of the user's face, such as image 704 and superimpose a graphic overlay 702 utilizing facial recognition software.

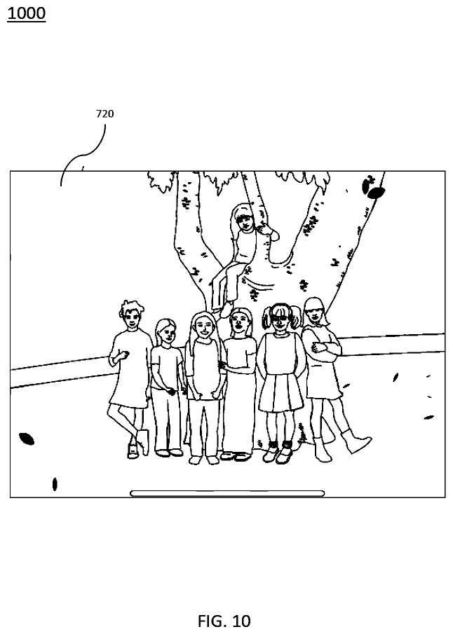

Referring now to FIG. 10, FIG. 10 is a screen shot of a graphic user interface 1000 that may be provided by, for example, a display device of an exemplary mobile device like mobile device 320. Graphic user interface 1000 shows is a graphical representation of a personalized augmented reality graphical overlay 702 in the form of fuzzy yellow dots superimposed over an image 702 of a group of players. As discussed above, in some implementations, upon completing the quest players may be rewarded with higher order emotional intelligence revelation. The revelation may include utilizing AR photo module 364 and/or API module 365 to input an image (e.g., a photograph) of the user's friends, such the image provided by FIG. 10 and superimpose a graphic overlay 702 utilizing, for example, object tracking recognition software.

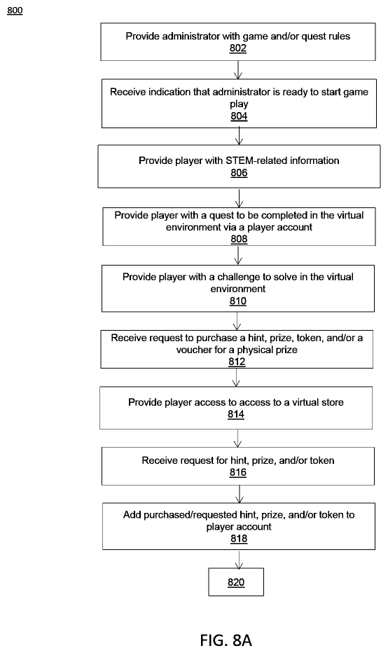

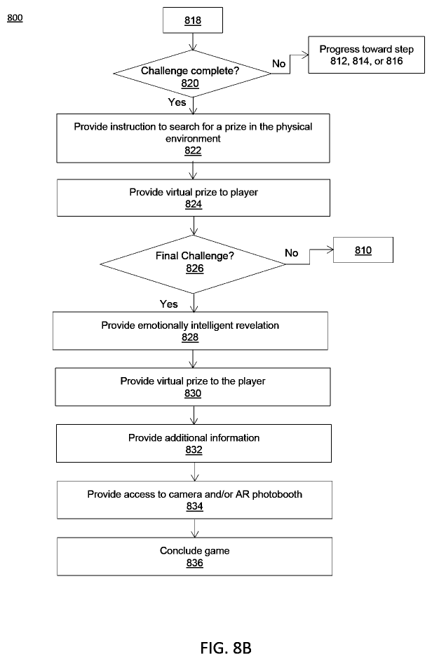

FIGS. 8A and 8B are flow charts depicting an exemplary process 800 for facilitating the play of an augmented reality game over three consecutive pages. Process 800 may be executed by, for example, any system or system component disclosed herein.

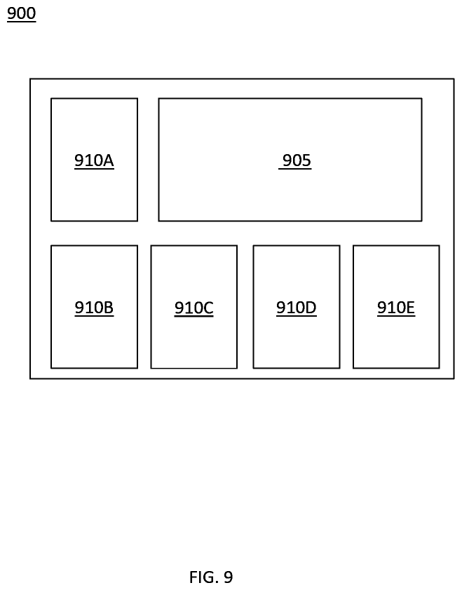

Initially, a game administrator may be provided with the quest for the augmented reality game (step 802). Augmented reality game quest may be provided via, for example, downloading the game to an electronic device (e.g., smart phone or tablet computer) operated by the administrator and/or via a kit like kit 900 discussed below with regard to FIG. 9. Some implementations include a bundled app and toy kit with instructions for mapping landmarks in a physical environment with landmarks in a virtual environment of the augmented reality game.

In step 804, an indication that the game administrator is ready to start the game, may be received. In some implementations this indication may represent a coupon redemption or software download. Another indication may represent that the game administrator has placed prizes in the physical environment according to the instructions.

Optionally, in step 806, the player may be provided with STEM-related information. In some cases, the STEM-related information may be useful for solving the challenge in the virtual world of the augmented reality game.

In step 808, a player of the augmented reality game may be provided with a quest to be completed in the virtual environment of the augmented reality game. The quest may include a plurality (e.g., 4, 5, 8, 10) of challenges to solve. In some embodiments, the number of challenges in a quest may be set by the administrator.

Provision of the quest may include provision of, for example, a story or background information pertaining to the quest or a challenge in the quest. In some cases, the player may be one of a group of players and the group of players (or the player individually) may work to solve the challenge in the virtual environment.

In step 810, a player may be provided with a first challenge of the plurality of challenges to solve in the virtual environment. When step 806 has been executed, the STEM-related information may be helpful in solving the first challenge.

In some instances, a request for to purchase a hint, prize, and/or token may be received (step 812) and, if so, the player may be provided with access to a virtual store via the augmented reality game (step 814).

While in the virtual store, the player may choose to purchase the hint, prize, token, using, for example, tokens as virtual currency provided to the virtual store via, for example, an e-commerce platform and the hint, prize, token may be provided to the user and a request for a hint, prize, and/or token may be received (step 816). In some embodiments, a request to use virtual currency tokens from the player to access a hint, a prize, and/or a digital asset may be received via the virtual store and an accounting and persistence of virtual currency tokens available to player, a cost of the at least one of hint, prize, and digital asset, and whether the tokes available to player are sufficient to pay the cost of the hint, prize, and/or digital asset may be determined. The accounting and persistence of virtual currency tokens available to player may be provided to the player via the virtual store and, if the player has a sufficient number of tokens available, the hint, prize, and/or digital asset may be provided to player and the cost of the hint, prize, and/or digital asset may be subtracted from the accounting of tokens available to the player.

In step 818, the requested and/or purchased hint, prize, and/or token may be added to the player account. For example, if the user decides to purchase or use tokens, then in step 818, tokens are added to their account. Additionally, or alternatively, a hint or digital asset useful to the challenge is added to the player account in step 818. In step 820, it may be determined if the user has completed, or solved, the challenge. When the challenge is solved, an instruction to search for a first prize proximate to a landmark in the physical environment that corresponds to a landmark in the virtual environment associated with the answer to the first challenge may be provided to the player (step 822). If the challenge is not solved, the player may, for example, return to step 818 for another hint or answer and/or return to step 816 to purchase virtual tokens. In addition, if the answer to 810 is solved a virtual prize may be provided to the player (step 824).

In step 826, it may be determined if the solved challenge is the final challenge of the quest and, if so, an emotionally intelligent revelation may be provided to the player (step 828). Also, the player may receive a virtual prize for completing the level and another virtual prize for completing the game (step 830). Optionally, the player may be notified that they have access to additional information (e.g., a STEM video, social intelligence information, emotional intelligence information, and/or negotiation skills training) that may serve to, for example, connect with what they have played and learned (step 832) during game play. The player may also be notified that they can commemorate their learning with, for example, a selfie and/or group AR photo that they may choose to share with friends and access to a camera and/or AR photobooth may be provided (step 834). In step 836, the game may conclude. In some embodiments, at the end of the game, the player may start a new game (step 810).

FIG. 9 is a block diagram of an exemplary kit 900 for use with the augmented reality game described herein. Kit 900 may include augmented reality game material 905 that may include, for example, instructions, cartridge or code (e.g., alpha-numeric and/or optical code) by which an administrator and/or player may receive information about the game or download the application. In some embodiments, material 905 may include information to supplement the augmented reality game such as a story, a poster, stickers, etc. Kit 900 also includes a plurality of prize packs 910A-910E. The prize packs 910A-910E may include physical prizes an administrator may place, or hide, in a physical environment that players of the game may discover throughout game play. Prize packs 910A-910E may include, for example, physical prizes like stickers, jewelry, toys, art supplies, and combinations thereof. In some instances, the prizes included in the one or more of the prize packs 910A-910E may be themed to correspond with the augmented reality game and/or a portion of the game. In some embodiments, each of prize packs 910A-910E may include a plurality (e.g., 5, 10, or 15) of the same prize (e.g., a prize for each player of the game). Alternatively, each of the prize packs 910A-910E may include a set of a plurality of different prizes so that each player (in this case 5 players) may be associated with a single prize pack 910.

Kits 900 may be sold via, for example, a retail store and/or an online store. Although kit 900 includes 5 prize packs 910A-910E, a kit 900 may include any number of prize packs 910.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred implementations, it is to be understood that such detail is solely for that purpose and that the disclosure is not limited to the expressly disclosed implementations, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A method for playing an augmented reality game, comprising:
providing, by a processor, a game administrator with game rules for the augmented reality game, the rules including instructions for mapping landmarks in a physical environment with landmarks in a virtual environment of the augmented reality game;
receiving, by the processor, an indication that the game administrator is ready to start the game, the indication representing that the game administrator has placed prizes in the physical environment according to the instructions;
providing, by the processor, the player with a quest to be completed in the virtual environment of the augmented reality game, the quest including a plurality of challenges to solve;
providing, by the processor, the player with a first challenge of the plurality of challenges;
receiving, by the processor, navigation instructions to move the player through the virtual environment;
determining, by the processor, that the player has successfully completed the first challenge responsively to where, in the virtual environment, the player has navigated to;
providing, by the processor, an instruction to search for a first prize proximate to a landmark in the physical environment that corresponds to a landmark in the virtual environment the player has navigated to in order to complete the first challenge;
providing, by the processor, a virtual prize and a second challenge to the player responsively to a determination that the first challenge is complete;
receiving, by the processor, navigation instructions to move the player through the virtual environment to solve the second challenge;
determining, by the processor, that the player has successfully completed the second challenge responsively to where, in the virtual environment, the player has navigated to;
determining, by the processor, whether the second challenge is a final challenge of the plurality of challenges; and
providing, by the processor, an emotionally intelligent revelation to the player responsively to a determination that the second challenge is a final challenge of the plurality of challenges.

2. The method of claim 1, further comprising:
providing, by the processor, access to a virtual store within the augmented reality game, at any point in the game.

3. The method of claim 1, further comprising:
receiving, by the processor, a request for a hint that may assist the player in solving at least one of the first challenge and the second challenge;
providing, by the processor, the requested hint to the player.

4. The method of claim 1, further comprising:
providing, by the processor, access to a virtual store within the augmented reality game;
receiving, by the processor, a request to purchase virtual currency tokens from the player; and
providing, by the processor, the requested virtual currency tokens responsively to a determination that the purchase has been successfully concluded.

5. The method of claim 1, further comprising:
providing, by the processor, access to a virtual currency tokens within the augmented reality game;
receiving, by the processor, a request to use virtual currency tokens from the player to access at least one of a hint, a prize, and a digital asset;
determining, by the processor, an accounting and persistence of virtual currency tokens available to player, a cost of the at least one of hint, prize, and digital asset, and whether the tokes available to player are sufficient to pay the cost of the at least one of hint, prize, and digital asset; and
providing, by the processor, an accounting and persistence of virtual currency tokens available to player and the at least one of hint, prize, and digital asset responsively to a determination that the tokens available to player are sufficient to pay the cost of the at least one of hint, prize, and digital asset.

6. The method of claim 1, further comprising:
providing, by the processor, additional information to the player prior to provision of the first challenge, or any time during game, the provided additional information being on a topic involving at least one of language arts, social intelligence, emotional intelligence, negotiation, and science, technology, engineering, and math (STEM) related information.

7. The method of claim 1, further comprising:
providing, by the processor, additional information to the player prior to provision of the first challenge, wherein the additional information teaches the player the laws of motion applied while playing the game.

8. The method of claim 1, further comprising:
providing, by the processor, additional information to the player prior to provision of the first challenge, wherein the additional information pertains to an avatar's or location in the virtual environment associated with all motion based challenges in the game.

9. The method of claim 1, further comprising:
providing, by the processor, additional information to the player after to provision of the second challenge, wherein the additional information provides the player with instruction on how to animate and code an animated augmented reality game of their own.

10. The method of claim 1, wherein the physical environment is at least one of a park, a museum, an area configured for playing the augmented reality game.

11. The method of claim 1, further comprising:
providing, by the processor, an antagonist in the virtual environment, wherein the antagonist acts in the virtual world of the augmented reality game to further challenge the player as they attempt to solve at least one of the first and second challenge.

12. The method of claim 1, further comprising:
receiving, by the processor, an indication that the player has paused the game to look for the physical prizes in the physical environment prior to providing the second challenge to the player.

13. The method of claim 1, further comprising:
receiving, by the processor, an indication that the player has paused the game to collaboratively problem solve level challenge in the game with other players.

14. The method of claim 1, further comprising:
receiving, by the processor, an indication that the player has the obtained the physical prize in the physical environment prior to providing the second challenge to the player.

15. The method of claim 1, further comprising:
providing, by the processor, at least one narrative character within the augmented reality game, the at least one narrative character being provided within the virtual environment and being configured to provide prompts to a user for imaginative role play.

16. The method of claim 1, wherein movement within the virtual world is controlled by a physics module running on the processor.

17. The method of claim 1, further comprising:
providing, by the processor, an instruction to the player encouraging the player to move in the physical environment.

18. The method of claim 1, further comprising:
providing, by the processor, an augmented reality photo booth.

19. The method of claim 1, further comprising:
providing, by the processor, a reward to the player responsively to a determination that the player solved at least one of the first challenge and the second challenge with a collaborator in the physical world.

20. The method of claim 1, further comprising:
receiving, by the processor, a request for an educational tutorial that may assist the player in learning a skill that may be used to solve at least one of the first challenge and the second challenge; and
providing, by the processor, the educational tutorial responsively to the request.

21. The method of claim 1, further comprising:
receiving, by the processor, a request for a digital asset that may assist the player in solving at least one of the first challenge and the second challenge or add an embellishment to the augmented reality game; and
providing, by the processor, the digital asset responsively to the request.

22. An augmented reality game system, the system comprising:
one or more processors configured to execute computer program modules, the computer program modules comprising:
a quest module configured to facilitate a user quest through a virtual environment and a physical environment;
a physics engine module configured to input movement data of a virtual player's movement in the virtual environment and output information indicating a virtual world location and movement of a first user avatar; and
an augmented reality photo module configured to superimpose a graphic overlay onto an image of the player in response to a notification from the quest module that the user has completed the user quest.

23. The augmented reality game system of claim 22, wherein the computer program modules further comprise:
a virtual store configured enable the player to purchase virtual currency tokens and provide the player with access to at least one of an accounting and persistence of at least one of virtual currency tokens, hints, prizes, and digital assets associated with a player account.
